(19) United States
(12) Patent Application Publication
(10) Pub. No.: US 2016/0131549 A1
(43) Pub. Date: May 12, 2016

(54) Dynamometer Calibrator for Wheelchair, Dynamometer for Wheelchair Including Same, and Method for Calibrating Dynamometer for Wheelchair Using Same

(71) Applicant: YONSEI UNIVERSITY WONJU INDUSTRY ACADEMIC COOPERATION FOUNDATION, Wonju-si (KR)

(72) Inventors: Jong-sang Son, Wonju-si (KR); Je-seong Ryu, Wonju-Si (KR); Seung-hyeon KIM, Wonju-si (KR); Young-ho Kim, Wonju-si (KR)

(73) Assignee: Yonsei University Wonju Industry-Academic Cooperation Foundation, Wonju-su (KR)

(21) Appl. No.: 14/769,280

(22) PCT Filed: Dec. 9, 2013
(86) PCT No.: PCT/KR2013/011352

§ 371 Date: Dec. 3, 2015

(30) Foreign Application Priority Data
Mar. 22, 2013 (KR) 10-2013-0031074

(51) Int. Cl. G01L 25/00; A61G 5/04

(52) U.S. Cl. CPC G01L 25/003; A61G 5/04

(57) ABSTRACT

A calibration apparatus for a wheelchair dynamometer include a body, a motor, a sensor, a wheel and a controller. The motor may be installed at the body to generate a torque. The sensor may be configured to measure a torque or a revolution per minute (RPM) generated from the motor. The wheel may be rotated by the torque. The controller may be configured to control the torque or the RPM generated from the motor and display a torque or a RPM measured by the sensor.

### CROSS-RELATED APPLICATION

This application claims priority under 35 USC §119 to Korean Patent Application No. 2013-31074169462, filed on Mar. 22, 2013 in the Korean Intellectual Property Office (KIPO), the contents of which are herein incorporated by reference in their entirety.

### BACKGROUND

1. Field

Example embodiments relate to a calibration apparatus for a wheelchair dynamometer, wheelchair dynamometer having the same, and a method of calibrating a wheelchair dynamometer using the same. More particularly, example embodiments relate to a calibration apparatus for calibrating a wheelchair dynamometer by comparing an actual torque with a measured torque of wheels of the wheelchair, a wheelchair dynamometer having the calibration apparatus, and a method of calibrating a wheelchair dynamometer using the calibration apparatus.

2. Description of the Related Art

Generally, a dynamometer may be test equipment configured to measure a torque and perform a test. The dynamometer may be used for obtaining data of a torque and a revolution per minute (RPM) of a vehicle such as a car. Thus, when the dynamometer may be used for a wheelchair, the dynamometer may be used for measuring a power of a wheel in the wheelchair.

Recently, various kinds of the wheelchair may be developed due to increasing of the elderly population and the disabled. Further, an electric wheelchair for convenience of users may be widely spread. Korean Patent Laid-Open Publication No. 2011-123616 may disclose a dynamometer for a wheelchair.

According to related arts, the dynamometer for the wheelchair may include an additional structure such as a bearing, a belt, etc., between a roller and a sensor. Thus, an actual torque generated in the wheelchair may be different from a torque measured using the dynamometer.

### SUMMARY

Example embodiments provide a calibration apparatus for a wheelchair dynamometer that may be capable of calibrating the wheelchair dynamometer by an actual torque generated in a wheel of the wheelchair with a torque measured using the dynamometer.

Example embodiments also provide a wheelchair dynamometer including the above-mentioned calibration apparatus.

Example embodiments still also provide a method of calibrating a wheelchair dynamometer using the above-mentioned calibration apparatus.

According to some example embodiments, there may be provided a calibration apparatus for a wheelchair dynamometer. The calibration apparatus for the wheelchair dynamometer may include a body, a motor, a sensor, a wheel and a controller. The motor may be installed at the body to generate a torque. The sensor may be configured to measure a torque or a revolution per minute (RPM) generated from the motor. The wheel may be rotated by the torque. The controller may be configured to control the torque or the RPM generated from the motor and display a torque or a RPM measured by the sensor.

In example embodiments, the calibration apparatus may further include a first shaft connected between the motor and the sensor, and a second shaft connected between the sensor and the wheel. The torque generated from the motor may be transmitted to the sensor through the first shaft. The torque may be transmitted from the first shaft to the wheel through the second shaft.

In example embodiments, the first shaft and the second shaft may transmit the torque by a belt and a pulley.

In example embodiments, the calibration apparatus may further include a frame extended from the body to support the body. The frame may be configured to space the wheel apart from a ground.

In example embodiments, the calibration apparatus may further include a pressing member arranged under the body to press the wheel toward a ground.

In example embodiments, the pressing member may include a lever fixed to the frame, a cable connected between the lever and the body, and a supporting roller configured to change directions of the cable.

According to some example embodiments, there may be provided a wheelchair dynamometer. The wheelchair dynamometer may include a calibration apparatus and a roller. The calibration apparatus may include a body, a motor, a sensor, a wheel and a controller. The motor may be installed at the body to generate a torque. The sensor may be configured to measure a torque or a revolution per minute (RPM) generated from the motor. The wheel may be rotated by the torque. The controller may be configured to control the torque or the RPM generated from the motor and display a torque or a RPM measured by the sensor. The roller may be configured to measure a torque of a wheel in the wheelchair.

In example embodiments, the wheelchair dynamometer may be movably arranged to contact the wheel with the roller or separate the wheel from the roller.

In example embodiments, the wheelchair dynamometer may further include a base fixed to the calibration apparatus to support the roller.

According to some example embodiments, there may be provided a method of calibrating a wheelchair dynamometer. In the method of calibrating the wheelchair dynamometer, a motor may be controlled to generate a target torque for rotating a wheel of the wheelchair. A torque generated from the wheel may be measured to obtain a measured torque. The target torque may be compared with the measured torque to correct the measured torque.

In example embodiments, controlling the motor may include setting the target torque generated from the motor, generating a torque from the motor, sensing a torque outputted from the motor, and comparing the sensed torque with target torque to adjust output of the motor in accordance with comparison results. Controlling the motor may further include sensing a torque outputted from the motor, and repeatedly comparing the sensed torque with the target torque to output the target torque after comparing the sensed torque with the target torque.

In example embodiments, controlling an output of the motor may include increasing the output of the motor when the target torque may be higher than the measured torque, and decreasing the output of the motor when the target torque may be lower than the measured torque.

In example embodiments, correcting the measured torque may include comparing a torque outputted from the wheel with the measured torque, and adding a difference value between the outputted torque and the measured torque to the measured torque to equalize the measured torque to the outputted torque.

In example embodiments, controlling the motor may include setting the target RPM generated from the motor, generating a torque from the motor, sensing an RPM outputted from the motor, and comparing the sensed RPM with target RPM to adjust output of the motor in accordance with comparison results. Controlling the motor may further include sensing an RPM outputted from the motor, and repeatedly comparing the sensed RPM with the target RPM to output the target RPM after comparing the sensed RPM with the target RPM.

In example embodiments, controlling an output of the motor may include increasing the output of the motor when the target RPM may be higher than the measured RPM, and decreasing the output of the motor when the target RPM may be lower than the measured RPM.

According to example embodiments, the calibration apparatus for the wheelchair dynamometer may calibrate the wheelchair dynamometer so that the wheelchair dynamometer may accurately measure the torque generated from the wheel of the wheelchair.

Further, the wheelchair dynamometer may include the pressing member configured to reflect weights of a user and the wheelchair to more accurately measure the torque of the wheelchair under various environments.

Furthermore, the method of calibrating the wheelchair dynamometer may allow the wheelchair dynamometer for accurately measuring the torque of the wheelchair.

### BRIEF DESCRIPTION OF THE DRAWINGS

Example embodiments will be more clearly understood from the following detailed description taken in conjunction with the accompanying drawings. FIGS. 1 to 7 represent non-limiting, example embodiments as described herein.

FIG. 1 is a perspective view illustrating a calibration apparatus for a wheelchair dynamometer in accordance with example embodiments;

FIG. 2 is a perspective view illustrating a body of the calibration apparatus in FIG. 1;

FIG. 3 is a perspective view illustrating the calibration apparatus in FIG. 1 applied to a wheelchair dynamometer;

FIG. 4 is a flow chart illustrating operations of a motor and a sensor in accordance with example embodiments;

FIG. 5 is a flow chart illustrating operations of a motor and a sensor in accordance with example embodiments;

FIG. 6 is a perspective view illustrating a pressing member of the calibration apparatus in FIG. 1; and

FIG. 7 is a cross-sectional view illustrating the pressing member in FIG. 6.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

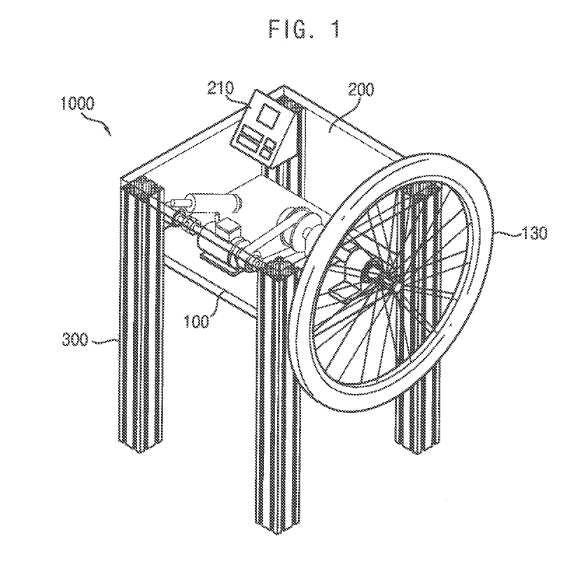

FIG. 1 is a perspective view illustrating a calibration apparatus for a wheelchair dynamometer in accordance with example embodiments.

Referring to FIG. 1, a calibrating apparatus 1000 for a wheelchair dynamometer may include a body 100, an upper cover 200, a frame 300, a controller 210 and a wheel 130.

The body 100 may have a rectangular plate shape. The body 100 may be configured to support elements for operating the wheel 130.

The frame 300 may be connected to the body 100 to support the body 100. The frame 300 may be extended from corners of the body 100 to provide the body 130 on the body 130 with a desired height. The body 100 may be slidably arranged on the frame 300. The body 100 may be selectively fixed to the frame 300.

The upper cover 200 may be arranged on the body 100 to cover the elements for operating the wheel 130 on the body 100.

The controller 210 may be arranged on the upper cover 200. The controller 210 may control a motor and a sensor.

The wheel 130 may be arranged at a side of the body 110. The wheel 130 may be rotatably connected to the body 110. The rotation of the wheel 130 may be controlled by the controller 210. The wheel 130 may be substantially the same as a wheel for the wheelchair. Alternatively, the wheel 130 may be substituted for other wheels in accordance with requirements. For example, the wheel 130 may be substituted for different kinds of a wheel used for measuring a torque.

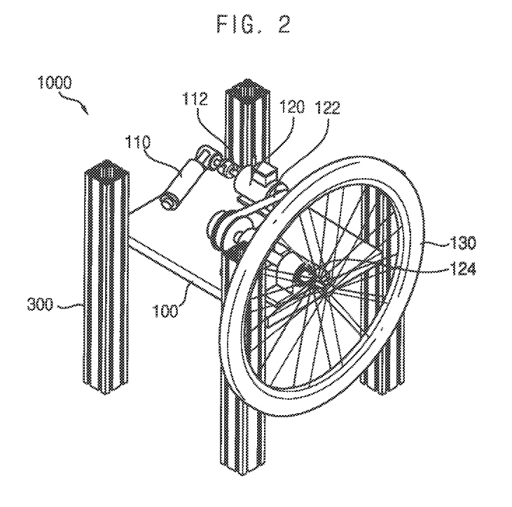

FIG. 2 is a perspective view illustrating a body of the calibration apparatus in FIG. 1.

Referring to FIG. 2, the calibration apparatus 1000 may further include a motor 110, a sensor 120 and the wheel on the body 100.

The motor 110 may be installed on the body 100 to provide a torque with the wheel 130. The motor 110 may be electrically connected with the controller 210. Thus, the controller 210 may control operations of the motor 110.

The sensor 120 may be arranged between the wheel 130 and the motor 110 to measure a torque generated from the motor 110 or an RPM of the motor 110. For example, the motor 110 may transfer a power to a first shaft 112. The sensor 120 connected to the first shaft 112 may measure the torque generated from the motor 110. Alternatively, the sensor 120 may measure the RPM of the first shaft 112. The sensor 120 may be electrically connected to the controller 210. The measured torque or RPM may be displayed on the controller 210.

The wheel 130 may be rotated by the motor 130. For example, the torque of the motor 110 may be transmitted to the first shaft 112. The first shaft 112 may be connected with a second shaft 124 via a pulley and a belt 122. The second shaft 124 may be connected to the wheel 130. Thus, the second shaft 124 and the wheel 130 may be rotated by the first shaft 112.

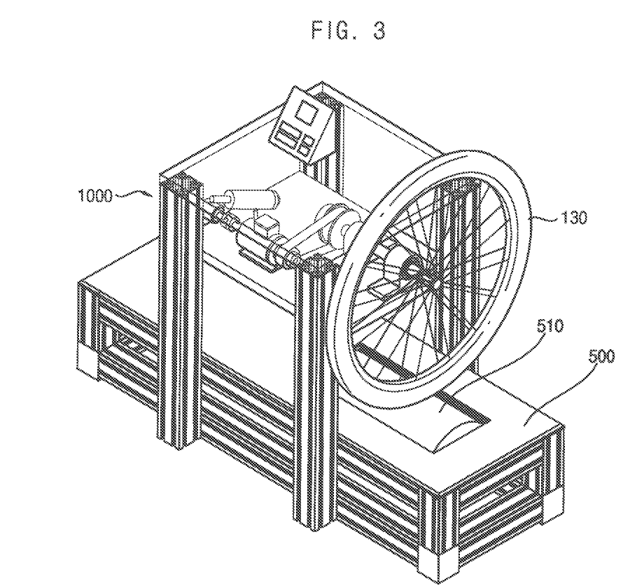

FIG. 3 is a perspective view illustrating the calibration apparatus in FIG. 1 applied to a wheelchair dynamometer.

Referring to FIG. 3, the wheelchair dynamometer may include a base 500 and a roller 510. The wheelchair dynamometer may sense a rotation of the roller 510 to measure a torque of the wheelchair. The wheel 130 of the calibration apparatus 1000 may make contact with the roller 510 of the wheelchair dynamometer.

The base 500 may be fixed to the frames 300 of the calibration apparatus 1000. Thus, the wheel 130 of the calibration apparatus 1000 may closely make contact with the roller 510 to form a sufficient frictional force between the wheel 130 and the roller 510.

The wheelchair dynamometer may measure the torque of the wheel 130 of the calibration apparatus 1000. The measured torque by the wheelchair dynamometer may be compared with an output torque outputted from the calibration apparatus 1000. The measured torque may be equaled to the output torque to create a corrected torque. For example, when the output torque may be higher than the measured torque, a difference value between the output torque and the measured torque may be added to the measured torque to obtain the corrected torque. Therefore, an actual wheelchair may be used in the wheelchair dynamometer to accurately measure an actual torque of the actual wheelchair.

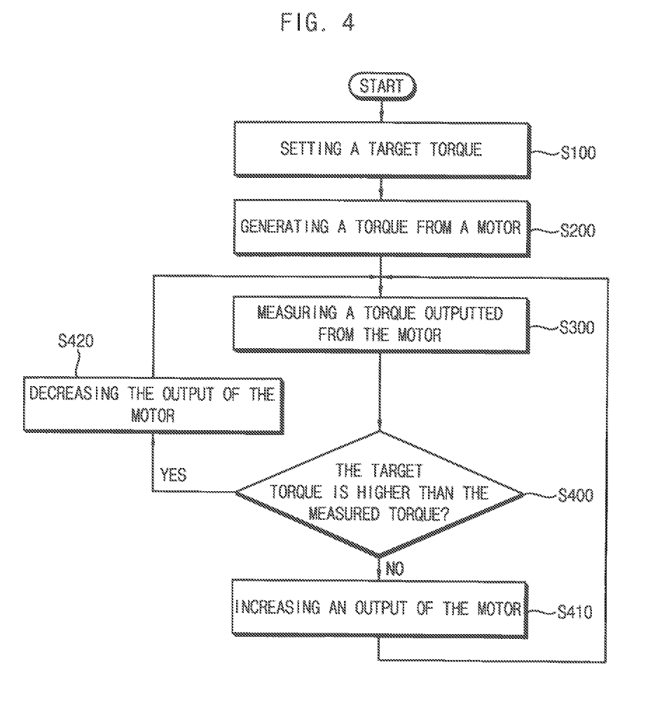

FIG. 4 is a flow chart illustrating operations of a motor and a sensor in accordance with example embodiments.

Referring to FIG. 4, in step S100, a target torque generated from the wheel 130 of the calibration apparatus may be set. In step S200, the motor 110 may be driven to generate the target torque from the wheel 130. In step S300, the sensor 120 may measure an output torque outputted from the wheel 130. In step S400, the measured torque may be compared with the target torque. When the target torque may be higher than the measured torque, in step S410, the output of the motor 110 may be increased. In contrast, in step S420, when the target torque may be lower than the measured torque, the output of the motor 110 may be decreased. Above-mentioned steps may be repeated to output the target torque from the wheel 130.

After outputting the target torque from the wheel 130, the wheelchair dynamometer may measure an output of the wheel 130 of the calibration apparatus. That is, the target torque outputted from the wheel 130 may be measured using the wheelchair dynamometer. The output torque outputted from the wheel 130 may be compared with the measured torque measured by the wheelchair dynamometer to obtain the corrected torque by equalizing the measured torque to the output torque.

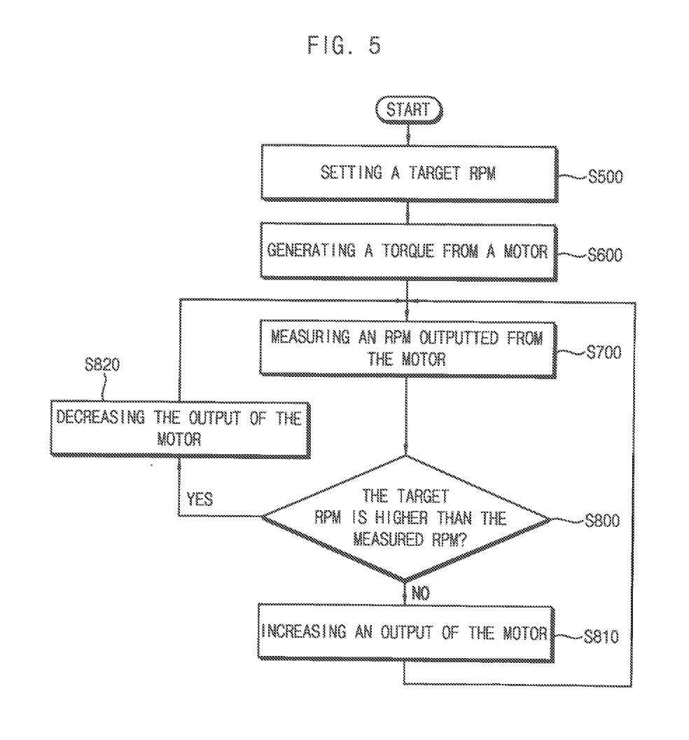

FIG. 5 is a flow chart illustrating operations of a motor and a sensor in accordance with example embodiments.

Referring to FIG. 5, in step S500, a target RPM corresponding a target torque, which may be generated from the wheel 130 of the calibration apparatus, may be set. In step S600, the motor 110 may be driven to generate the target RPM from the wheel 130. In step S700, the sensor 120 may measure an output RPM outputted from the wheel 130. In step S800, the measured RPM may be compared with the target RPM. When the target RPM may be higher than the measured RPM, in step S810, the output of the motor 110 may be increased. In contrast, in step S820, when the target RPM may be lower than the measured RPM, the output of the motor 110 may be decreased. Above-mentioned steps may be repeated to output the target RPM from the wheel 130.

After outputting the target RPM from the wheel 130, the wheelchair dynamometer may measure an output of the wheel 130 of the calibration apparatus. That is, the target RPM outputted from the wheel 130 may be measured using the wheelchair dynamometer. The output RPM outputted from the wheel 130 may be compared with the measured RPM measured by the wheelchair dynamometer to obtain the corrected RPM by equalizing the measured RPM to the output RPM.

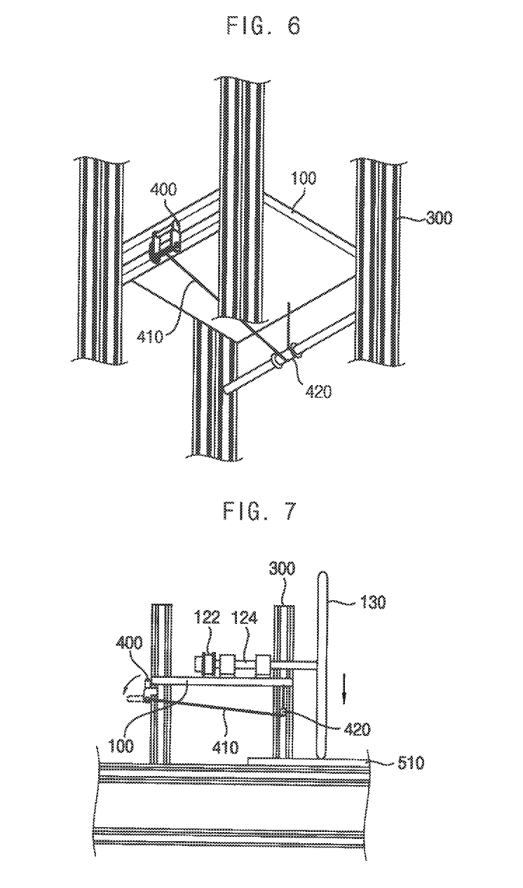

FIG. 6 is a perspective view illustrating a pressing member of the calibration apparatus in FIG. 1, and FIG. 7 is a cross-sectional view illustrating the pressing member in FIG. 6.

Referring to FIGS. 6 and 7, the calibration apparatus may further include a pressing member arranged under the body 100.

When the calibration apparatus may be applied to the wheelchair dynamometer, the pressing member may be configured to apply a force, which may correspond to a summed weight of a user and the wheelchair, to the wheel 130. Thus, an actual torque generated when the user may use the wheelchair may be accurately measured.

The pressing member may include a lever 400, a cable 410 and a supporting roller 420. The lever 400 may be fixed to the frame 300. The cable 410 may be connected to the lever 400. The lever 400 may be configured to apply a tensile force to the cable 410. The cable 410 may be connected between the lever 400 and the body 100. The supporting roller 420 may be rotatably connected to the frame 300. The cable 410 may function as to change a direction of the tensile force by the supporting roller 420 to apply a downward force to the body 100.

According to example embodiments, the calibration apparatus for the wheelchair dynamometer may calibrate the wheelchair dynamometer so that the wheelchair dynamometer may accurately measure the torque generated from the wheel of the wheelchair.

Further, the wheelchair dynamometer may include the pressing member configured to reflect weights of a user and the wheelchair to more accurately measure the torque of the wheelchair under various environments.

Furthermore, the method of calibrating the wheelchair dynamometer may allow the wheelchair dynamometer for accurately measuring the torque of the wheelchair.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A calibration apparatus for a wheelchair dynamometer comprising:
a body;
a motor mounted on the body to generate a torque;
a sensor configured to measure the torque or a revolution per minute (RPM) generated from the motor;
a wheel rotated by the torque generated from the wheel; and
a controller configured to control the torque or the RPM of the motor and to display a torque or an RPM measured by the sensor.

2. The calibration apparatus for a wheelchair dynamometer of claim 1, further comprising:
a first shaft arranged between the motor and the sensor; and
a second shaft arranged between the sensor and the wheel,
wherein the torque generated from the motor is transmitted to the wheel through the first shaft, the sensor and the second shaft.

3. The calibration apparatus for a wheelchair dynamometer of claim 2, wherein the first shaft and the second shaft are connected with each other via a belt and a pulley.

4. The calibration apparatus for a wheelchair dynamometer of claim 1, further comprising a frame extended from the body to support the body, the frame configured to space the wheel apart from a ground.

5. The calibration apparatus for a wheelchair dynamometer of claim 1, further comprising a pressing member arranged under the body to apply a downward force to the wheel.

6. The calibration apparatus for a wheelchair dynamometer of claim 5, wherein the pressing member comprises:
a lever fixed to the frame;
a cable connected between the lever and the body; and
a supporting roller configured to change a direction of the cable.

7. A wheelchair dynamometer comprising:
a calibration apparatus including a body, a motor, a sensor, a wheel and a controller, the motor mounted on the body to generate a torque, the sensor configured to measure the torque or a revolution per minute (RPM) generated from the motor, the wheel rotated by the torque generated from the wheel, and the controller configured to control the torque or the RPM of the motor and to display a torque or an RPM measured by the sensor; and
a roller configured to measure a torque of a wheel in a wheelchair.

8. The wheelchair dynamometer of claim 7, wherein the wheelchair dynamometer is movably arranged to contact the wheel the roller or separate the wheel from the roller.

9. The wheelchair dynamometer of claim 7, further comprising a based fixed to the calibration apparatus to support the roller.

10. A method of calibration a wheelchair dynamometer, the method comprising:
generating a target torque, which is used for rotate a wheel, from a motor;
measuring a torque generated from the wheel to obtain a measured torque; and
comparing the target torque with the measured torque to correct the measured torque by equalizing the measured torque to the target torque.

11. The method of claim 10, wherein generating the target torque comprises:
setting the target torque to be generated from the wheel;
generating a torque from the motor;
measuring the torque outputted from the motor;
comparing the measured torque with the target torque to increase the output of the motor when the target torque is higher than the measured torque and to decrease the output of the motor when the target torque is lower than the measured torque; and
repeating measuring the torque and comparing the measured torque with the target torque.

12. The method of claim 10, wherein correcting the measured torque comprises comparing an output torque outputted from the wheel with the measured torque to add a difference value between the output torque and the measured torque by equalizing the measured torque to the output torque.

13. The method of claim 10, wherein generating the target torque comprises:
setting the target RPM to be generated from the wheel;
generating a torque from the motor;
measuring an RPM outputted from the motor;
comparing the measured RPM with the target RPM to increase the output of the motor when the target RPM is higher than the measured RPM, and to decrease the output of the motor when the target RPM is lower than the measured RPM; and
repeating measuring the RPM and comparing the measured RPM with the target RPM.
